(19) United States
(12) Patent Application Publication
(10) Pub. No.: US 2022/0341957 A1
(43) Pub. Date: Oct. 27, 2022

(54) In-situ successively fixing rolling type holding device for use in a low-temperature environmental test chamber

(71) Applicants: Yongjie Zhang, Xian (CN); Yunhui Zhang, Xian (CN); Guisen Luo, Xian (CN)

(72) Inventors: Yongjie Zhang, Xian (CN); Yunhui Zhang, Xian (CN); Guisen Luo, Xian (CN)

(21) Appl. No.: 17/372,421

(22) Filed: Jul. 10, 2021

(30) Foreign Application Priority Data
Apr. 21, 2021 (CN) 202110432234. 3

(51) Int. Cl. G01N 35/04; G01N 17/00

(52) U.S. Cl. CPC G01N 35/04; G01N 17/002; G01N 2035/0486; G01N 2035/0475; G01N 2035/046

(57) ABSTRACT

The present disclosure provides an in-situ successively fixing rolling type holding device for use in a low-temperature environmental test chamber. The holding device includes a bracket, multiple holding components, and a conveying device. The bracket is fixed in the low-temperature environmental test chamber. The driving mechanism is used for driving the conveying member to rotate, thus making multiple test articles successively pass through the test position in the low-temperature environmental test chamber for the in-situ measurement. The present disclosure can reduce the times of door opening of the low-temperature environmental test chamber during the successive in-situ measurements of multiple test articles in the low-temperature environmental test chamber, thus preventing the door opening and closing of the low-temperature environmental test chamber and the transfer of test article from causing the temperature fluctuation in the temperature field where the test articles are located.

### TECHNICAL FIELD

The present disclosure involves the technical field of low-temperature environmental test tools, more specifically, an in-situ successively fixing rolling type holding device for use in a low-temperature environmental test chamber.

### BACKGROUND

Airplanes, amphibious aircraft, polar ships, and offshore platforms are all faced with the impact of icing during their operation. In view of this, some anti-icing and de-icing methods are often adopted in the design and manufacture process to reduce the impact of icing on airplanes, amphibious aircraft, polar ships, and offshore platforms. The application of anti-icing and de-icing coating layers is a commonly used method. The anti-icing and de-icing coating layers are made of super-hydrophobic coating or low surface energy coating. In order to verify the performance of anti-icing and de-icing coating layers, in addition to the method of applying the anti-icing and de-icing coating on certain parts of the body of the airplane or ship for field verification, the environmental test system can be erected in the laboratory to conduct the low-temperature environmental test for simulating the anti-icing and de-icing performance of the anti-icing and de-icing coating layers at a low temperature. The comparison shows that the latter has a lower cost and is less susceptible to the limitations of time and space.

During the test in the low-temperature environmental test chambers in a laboratory, for some small and medium-sized environmental test chambers, it is necessary to open the door of the test chamber for clamping the test articles or transferring the test articles to the testbed for the test. However, such operations and steps will inevitably lead to temperature fluctuation in the temperature field where the test articles are located. Such temperature fluctuation will directly affect the accuracy and reliability of the measurement results obtained in the low-temperature environmental test.

### SUMMARY

The present disclosure provides an in-situ successively fixing rolling type holding device for use in a low-temperature environmental test chamber. The present disclosure can reduce the times of door opening of the low-temperature environmental test chamber during the successive in-situ measurements of multiple test articles in the low-temperature environmental test chamber, thus preventing the door opening and closing of the low-temperature environmental test chamber and the transfer of test article from causing the temperature fluctuation in the temperature field where the test articles are located.

Technical solution of the present disclosure:

An in-situ successively fixing rolling type holding device for use in a low-temperature environmental test chamber, including:

a bracket, which is fixed in the low-temperature environmental test chamber;

multiple holding components, with each holding component used for holding one test article; and

a conveying device, which includes:

a conveying member, which is detachably connected by connecting components with the holding components; and

a driving mechanism, which is fixed on the bracket and used for driving the conveying member to rotate, thus making multiple test articles successively pass through the test position in the low-temperature environmental test chamber for the in-situ measurement.

The above-mentioned holding components include:

the first holding block, which includes the first bearing part for bearing the test article, the first clamping part for clamping the test article is fixed on the left side of the first bearing part, and the bulge is fixed on the right side of the first bearing part;

the second holding block, which includes the second bearing part for bearing the test article, the second clamping part for clamping the test article is fixed on the right side of the second bearing part, and a notch matching the bulge is cut on the left side of the second bearing part; and

an elastic telescopic piece, one end of which is fixedly connected with the bulge and the other end of which is fixedly connected with the notch.

The above-mentioned conveying member is a chain. The chain includes multiple chain links arranged in series. The first bearing part or the second bearing part of each holding component is detachably bolted with the chain link.

The above-mentioned driving mechanism includes:

a drive sprocket, which is engaged with the chain;

the first sprocket shaft, which runs through the center of the drive sprocket and the left and right ends of which are connected by bearings with the bracket;

a driven sprocket, which is engaged with the chain;

the second sprocket shaft, which runs through the center of the driven sprocket and the left and right ends of which are connected by bearings with the bracket; and

a motor, the output shaft of which is connected by the transmission mechanism with the first sprocket shaft, and the outer shell of which is fixed onto the bracket.

The fixing device used for fixing the test article is arranged on the part of the above-mentioned bracket at the test position in the low-temperature environmental test chamber. The fixing device includes:

a lower fixing device, which is fixed on the bracket for supporting the test article; and

an upper fixing device, which is fixed on the bracket for pressing down the test article.

The above-mentioned lower fixing device includes:

a support rod, the lower end of which is fixedly connected with the bracket; and

the first disc, the lower surface of which is fixedly connected with the upper end of the support rod and the upper end of which is in contact with the lower surface of the test article.

The above-mentioned upper fixing device includes:

a support frame, which is fixed onto the bracket;

an electric push rod, the outer shell of which is fixed onto the support frame and the telescopic end of which is vertically downward; and

the second disc, the upper surface of which is fixedly connected with the telescopic end of the electric push rod and the lower surface of which is in contact with the upper surface of the test article;

The electric push rod moves downwards to drive the second disc to move downwards and cooperate with the first disc to clamp the test article.

1. Beneficial effects of the present disclosure:

In the prior art, during the low-temperature environmental test, it is common that only one test article can be tested every time the door of the test chamber is opened and closed. As a result, such repeated door opening of the test chamber will inevitably lead to temperature fluctuation in the temperature field where the test articles are located. Such temperature fluctuation will directly affect the accuracy and reliability of the measurement results obtained in the low-temperature environmental test. Meanwhile, in the prior art, it is impossible to perform the in-situ measurement when multiple test articles are measured once, which increases the difficulty in the control of variables during the test and further affects the accuracy of the measurement results. In comparison, in the present disclosure, multiple holding components are used to hold multiple test articles and are detachably bolted with the chain; the driving mechanism drives the chain to rotate, thus making multiple test articles successively pass through the test position in the low-temperature environmental test chamber; after each test article reaches the test position, the low-temperature test will be conducted; after a test is completed, the chain drives another test article to the test position for the in-situ measurement. In this way, the measurement of a batch of test articles can be performed without opening the door of the low-temperature environmental test chamber.

2. The present disclosure starts from two aspects concerning the test articles, i.e. holding and fixing, omits the repeated operations, reduces the test time, and improves the test efficiency. In addition, the test articles of different sizes are provided for the holding components, thus meeting the test requirements for test articles of different sizes.

3. The holding components in the present disclosure include the first holding block, the second holding block, and an elastic telescopic piece. The elastic telescopic piece can adjust the distance between the first holding block and the second holding block to match the test articles of different sizes.

### BRIEF DESCRIPTION OF DRAWINGS

FIG. 1 is a three-dimensional view of the overall structure of the present disclosure.

FIG. 2 is a front view of the overall structure of the present disclosure.

FIG. 3 is a side view of the overall structure of the present disclosure.

FIG. 4 is a schematic diagram of the holding status of a test article of the present disclosure.

FIG. 5 is a structural view of the holding component of the present disclosure.

FIG. 6 is a partial enlarged drawing of the chain of the present disclosure;

FIG. 7 is a schematic diagram of the structure fixed in the low-temperature environmental test chamber in the present disclosure.

### EXPLANATION OF MARKS ON THE DRAWINGS

1. bracket; 2. drive sprocket; 3. driven sprocket; 4. motor; 5. first holding block; 51. first bearing part; 52. first clamping part; 53. bulge; 6. second holding block; 61. second bearing part; 62. second clamping part; 63. notch; 7. upper fixing device; 8. lower fixing device; 9. test article; 10. elastic telescopic piece; 11. chain; 12. first sprocket shaft; 13. second sprocket shaft; 14. support rod; 15. first disc; 16. support frame; 17. electric push rod; 18. second disc; 19. low-temperature environmental test chamber; 20. operating hole.

### DETAILED DESCRIPTION OF THE PREFERRED EMBODIMENTS

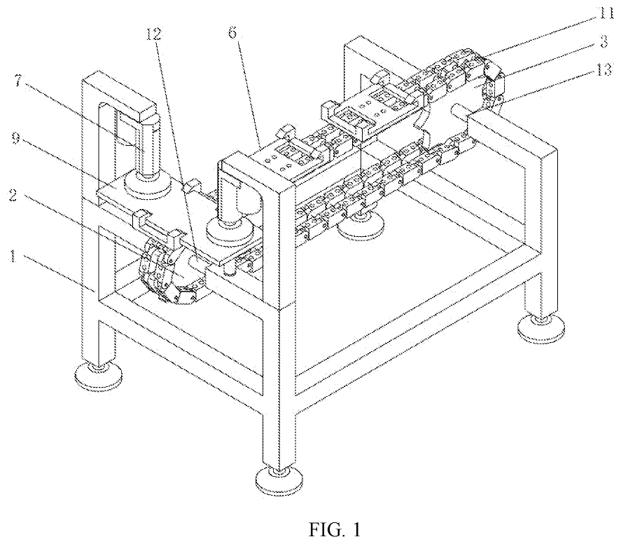

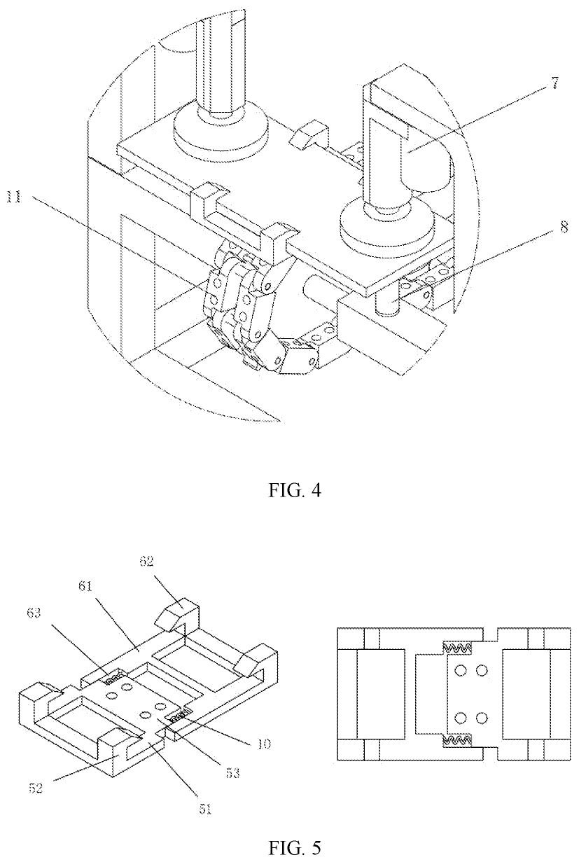

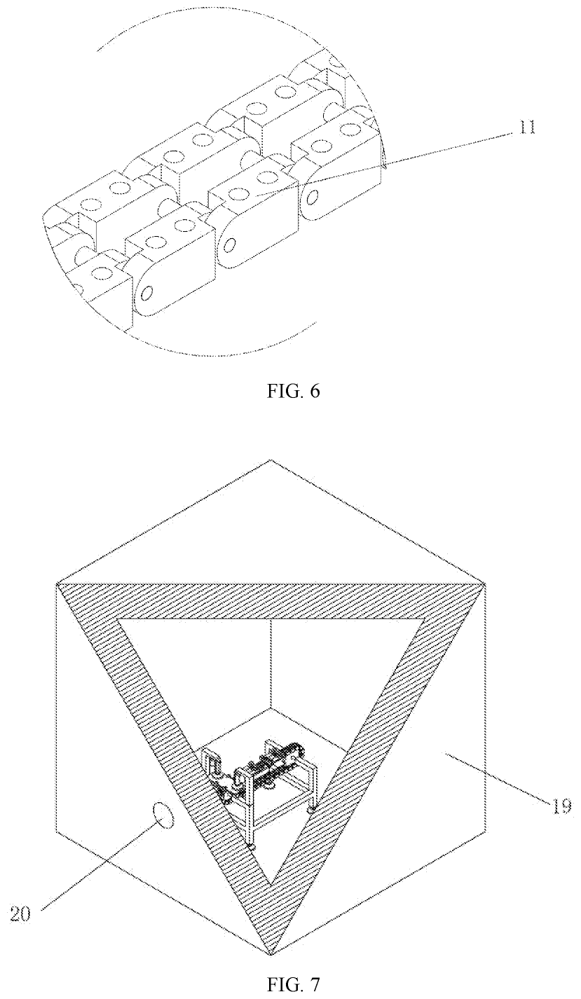

A detailed description of the preferred embodiments of the present disclosure is provided in conjunction with FIG. 1 to FIG. 7. However, it is to be understood that the scope of protection of the present disclosure is not limited by the detailed description of the preferred embodiments.

### Embodiment 1

As illustrated in FIG. 1, this embodiment of the present disclosure provides an in-situ successively fixing rolling type holding device for use in a low-temperature environmental test chamber. The holding device includes a bracket, multiple holding components, and a conveying device. The bracket is fixed in the low-temperature environmental test chamber, as illustrated in FIG. 7. Each holding component is used for holding one test article 9. The conveying device includes a conveying member and a driving mechanism. The conveying member is detachably connected by connecting components with the holding components. The driving mechanism is fixed on bracket 1 and used for driving the conveying member to rotate, thus making multiple test articles 9 successively pass through the test position in the low-temperature environmental test chamber for the in-situ measurement.

The present disclosure provides an in-situ successively fixing rolling type holding device for use in a low-temperature environmental test chamber. The present disclosure can reduce the times of door opening of the low-temperature environmental test chamber during the successive in-situ measurements of multiple test articles in the low-temperature environmental test chamber, thus preventing the door opening and closing of the low-temperature environmental test chamber and the transfer of test article from causing the temperature fluctuation in the temperature field where the test articles are located. In the present disclosure, multiple holding components are used to hold multiple test articles and are detachably bolted with the chain; the driving mechanism drives the chain to rotate, thus making multiple test articles successively pass through the test position in the low-temperature environmental test chamber; after each test article reaches the test position, the low-temperature test will be conducted; after a test is completed, the chain drives another test article to the test position for the in-situ measurement. In this way, the measurement of a batch of test articles can be performed without opening the door of the low-temperature environmental test chamber.

### Embodiment 2

This embodiment is based on Embodiment 1 and illustrated in FIG. 5. The holding components in the present disclosure include the first holding block 5, the second holding block 6, and the elastic telescopic piece 10. The first holding block 5 includes the first bearing part 51 for bearing the test article 9, the first clamping part 52 for clamping the test article 9 is fixed on the left side of the first bearing part 51, and the bulge 53 is fixed on the right side of the first bearing part 51. The second holding block 6 includes the second bearing part 61 for bearing the test article 9, the second clamping part 62 for clamping the test article 9 is fixed on the right side of the second bearing part 61, and the notch 63 matching the bulge 53 is cut on the left side of the second bearing part 61. One end of the elastic telescopic piece 10 is fixedly connected with the bulge 53 and the other end is fixedly connected with the notch 63.

The present disclosure provides an in-situ successively fixing rolling type holding device for use in a low-temperature environmental test chamber that includes the first holding block, the second holding block, and an elastic telescopic piece. The elastic telescopic piece can adjust the distance between the first holding block and the second holding block to match the test articles of different sizes. The test article 9 is placed on the first bearing part 51 and the second bearing part 61. Under the elastic force of the spring, the first clamping part 52 and the second clamping part 62 clamp the left and right sides of the test article. Meanwhile, since the spring is elastic, the distance between the first clamping part 52 and the second clamping part 62 can be adjusted according to the size of the test article to ensure that the test article 9 is always clamped.

### Embodiment 3

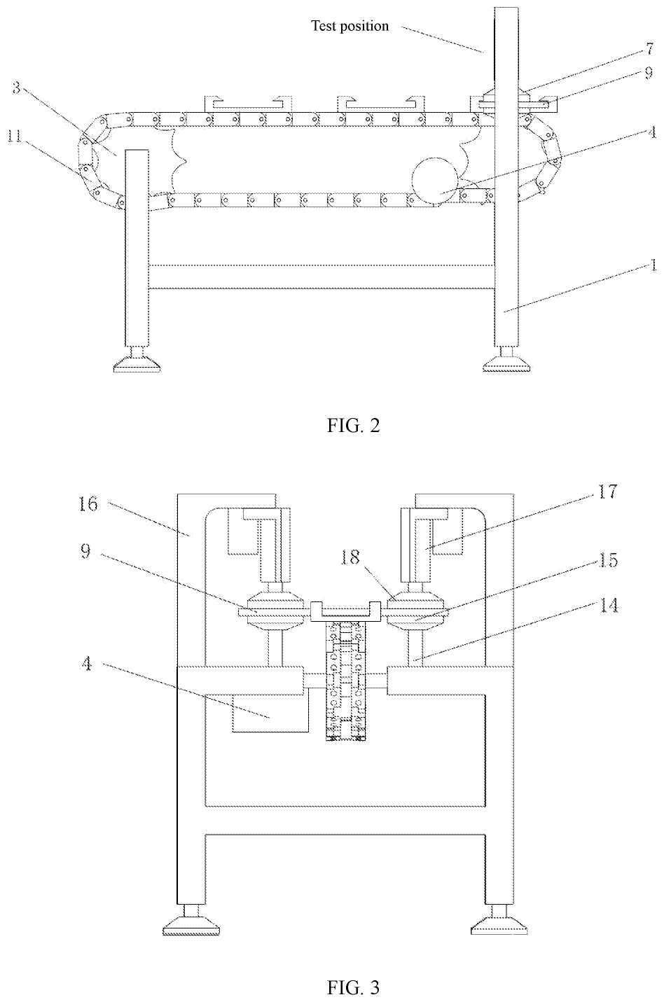

This embodiment is based on Embodiment 2 and illustrated in FIG. 2. The conveying member is a chain 11. The chain 11 includes multiple chain links arranged in series. The first bearing part 51 or the second bearing part 61 of each holding component is detachably bolted with the chain link.

Further, the driving mechanism includes a drive sprocket 2. The drive sprocket 2 engages with the chain 11. The center of the drive sprocket 2 is arranged with the first sprocket shaft 12. Both ends of the first sprocket shaft 12 are connected by bearings with the bracket 1. The chain 11 also engages with the driven sprocket 3. The center of the driven sprocket 3 is arranged with the second sprocket shaft 13. Both ends of the second sprocket shaft 13 are also connected by bearings with the bracket 1. One end of the first sprocket shaft 12 is connected by a transmission mechanism with the output shaft of the motor 4. The outer shell of the motor 4 is fixed onto the bracket 1.

The present disclosure provides an in-situ successively fixing rolling type holding device for use in a low-temperature environmental test chamber. The control switch of the motor 4 is fixed on the outer surface of the low-temperature environmental test chamber. The gear motor 4 is started from the outside of the test chamber. The gear motor 4 drives the drive sprocket 2 to rotate, thus driving the driven sprocket 3 and the test article conveying chain 11 to operate. After the test article 9 installed on the test article holding component 6 is conveyed by the test article conveying chain 11 and reaches the test position, the gear motor 4 is turned off After the gear motor 4 is turned off, the control switch of the electric push rod 17 is closed, after which the upper fixing device moves downwards to match the lower fixing device, thus clamping the test article in the vertical direction and fixing the test article. After that, the corresponding mechanical test can be conducted. After the test is completed, the upper fixing device is released. The test article 9 is released, so it can move along with the test article holding component. The gear motor 4 is restarted, after which the test article conveying chain 11 continues to operate. The test article already completing the test is driven by the test article conveying chain 11 to rotate to a position below such chain. The clamping function of the test article holding component ensures that the test article is clamped and does not fall off. The new test article is conveyed to the test position for the test. This process is repeated to complete the test of the entire batch of test articles.

### Embodiment 4

This embodiment is based on Embodiment 2 and illustrated in FIG. 3. The fixing device used for fixing the test article 9 is arranged on the part of the bracket 1 at the test position in the low-temperature environmental test chamber. The fixing device includes a lower fixing device and an upper fixing device. The lower fixing device is fixed on the bracket 1 for supporting the test article 9. The upper fixing device is fixed on the bracket 1 for pressing down the test article 9.

Further, the lower fixing device includes a support rod 14, the lower end of which is fixedly connected with the bracket 1. The upper end of the support rod 14 is fixedly connected with the lower surface of the first disc 15, and the upper surface of the first disc 15 is in contact with the lower surface of the test article 9.

Further, the upper fixing device includes a support frame 16, an electric push rod 17, and the second disc 18. The support frame 16 is fixed on the bracket 1, and the outer shell of the electric push rod 17 is fixed on the support frame 16. The telescopic end of the electric push rod 17 is vertically downward and fixedly connected with the upper surface of the second disc 18. The lower surface of the second disc 18 is in contact with the upper surface of the test article 9. The electric push rod 17 moves downwards to drive the second disc 18 to move downwards and cooperate with the first disc 15 to clamp the test article 9.

In the present disclosure, a test article fixing device is installed on the side of the bracket 1 next to the loading side. The test article fixing device includes a lower fixing device 8 and an upper fixing device 7. The lower fixing device 8 is fixedly connected with the bracket 1. The first disc 15 of the lower fixing device 8 is in contact with the lower surface of the test article 9. An electric push rod is used for the upper fixing device 7. The control switch of the electric push rod is fixed outside the low-temperature environmental test chamber. The electric push rod drives the second disc 18 to move downwards to contact with the upper surface of the test article 9. The contact parts of the first disc 15 and the second disc 18 with the test article are made of rubber materials to prevent damage to the surface of the test article during the fixing operations.

The operating principle of the present disclosure is as follows: The present disclosure provides an in-situ successively fixing rolling type holding device for use in a low-temperature environmental test chamber. A drive sprocket 2 and a driven sprocket 3 are installed on a bracket 1 by the bearings matching the sprocket shaft. The drive sprocket 2 is driven by a gear motor 4. The gear motor 4 provides the drive sprocket 2 with the required tractive force. A test article conveying chain 5 is installed on the drive sprocket 2 and the driven sprocket 3. The test article conveying chain 5 is driven by drive sprocket 2 and the driven sprocket 3 to circulate. The test article holding component is fixed by bolts on the chain links of the test article conveying chain 5. In addition, a test article fixing device is installed on the side of the bracket 1 next to the loading side. The test article fixing device includes a lower fixing device 8 and an upper fixing device 7. The lower fixing device 8 is fixedly connected with the bracket 1. The upper fixing device 7 is a movable part and can move up and down in the vertical direction. The contact parts of such two components with the test article are made of rubber materials to prevent damage to the surface of the test article during the fixing operations.

During the test, the whole device is placed in a low-temperature environmental test chamber. The test article holding component 6 is installed on the test article conveying chain 11 through the holes matching the threaded holes on the chain links. According to the length of the test article conveying chain 11, it is possible to choose multiple test article holding components to perform multiple tests simultaneously. During the test, the test article 9 is placed on the test article holding component. The test article holding component includes two parts (as illustrated in FIG. 5). Such two parts are connected by a spring that provides the tensile force. As a result, the size can be adjusted, and a certain clamping force can be generated to clamp the test article 9 to prevent it from falling off Later, the gear motor 4 is started from the outside of the test chamber. The gear motor 4 drives the drive sprocket 2 to rotate, thus driving the driven sprocket 3 and the test article conveying chain 11 to operate. After the test article 9 installed on the test article holding component 6 is conveyed by the test article conveying chain 11 and reaches the test position, the gear motor is turned off. The upper fixing device 7 moves downwards to match the lower fixing device 8, thus clamping the test article in the vertical direction and fixing the test article. After that, the corresponding mechanical test can be conducted. After the test is completed, the upper fixing device 7 is released. The test article 9 is released, so it can move along with the test article holding component. The gear motor 4 is restarted, after which the test article conveying chain 11 continues to operate. The test article already completing the test is driven by the test article conveying chain 11 to rotate to a position below such chain. The clamping function of the test article holding component ensures that the test article is clamped and does not fall off. The new test article is conveyed to the test position for the test. This process is repeated to complete the test of the entire batch of test articles.

In this way, it is only required to operate the gear motor and the test article fixing device outside the low-temperature environmental test chamber when conducting the in-situ measurement test in the low-temperature environmental test chamber. As a result, it is not required to open and close the door of the test chamber, thus eliminating the impact of temperature fluctuation on the test results and improving the accuracy of measurement. In addition, the tests can be conducted on multiple test articles one by one, thus eliminating the repeated assembly and disassembly of the test articles and reducing the test time.

To sum up, the present disclosure provides an in-situ successively fixing rolling type holding device for use in a low-temperature environmental test chamber. The present disclosure can reduce the times of door opening and closing of the low-temperature environmental test chamber during the successive in-situ measurements of multiple test articles in the low-temperature environmental test chamber, thus preventing the door opening and closing of the low-temperature environmental test chamber and the transfer of test article from causing the temperature fluctuation in the temperature field where the test articles are located.

1. An in-situ successively fixing rolling type holding device for use in a low-temperature environmental test chamber, which is characterized in that it includes:
a bracket (1), which is fixed in the low-temperature environmental test chamber; and
multiple holding components, with each holding component used for holding one test article (9); and
a conveying device, which includes:
a conveying member, which is connected by connecting components with the holding components; and
a driving mechanism, which is fixed on the bracket (1) and used for driving the conveying member to rotate, thus making multiple test articles (9) successively pass through the test position in the low-temperature environmental test chamber for the in-situ measurement.

2. The in-situ successively fixing rolling type holding device for use in a low-temperature environmental test chamber as claimed in claim 1, which is characterized in that the holding components include:
the first holding block (5), which includes the first bearing part (51) for bearing the test article (9), the first clamping part (52) for clamping the test article (9) is fixed on the left side of the first bearing part (51), and the bulge (53) is fixed on the right side of the first bearing part (51);
the second holding block (6), which includes the second bearing part (61) for bearing the test article (9), the second clamping part (62) for clamping the test article (9) is fixed on the right side of the second bearing part (61), and a notch (63) matching the bulge (53) is cut on the left side of the second bearing part (61); and
an elastic telescopic piece (10), one end of which is fixedly connected with the bulge (53) and the other end of which is fixedly connected with the notch (63).

3. The in-situ successively fixing rolling type holding device for use in a low-temperature environmental test chamber as claimed in claim 2, which is characterized in that the conveying member is a chain (11). The chain (11) includes multiple chain links arranged in series. The first bearing part (51) or the second bearing part (61) of each holding component is detachably bolted with the chain link.

4. The in-situ successively fixing rolling type holding device for use in a low-temperature environmental test chamber as claimed in claim 3, which is characterized in that the driving mechanism includes:
a drive sprocket (2), which is engaged with the chain (11);
the first sprocket shaft (12), which runs through the center of the drive sprocket (2) and the left and right ends of which are connected by bearings with the bracket (1);
a driven sprocket (3), which is engaged with the chain (11);
the second sprocket shaft (13), which runs through the center of the driven sprocket (3) and the left and right ends of which are also connected by bearings with the bracket (1); and
a motor (4), the output shaft of which is connected by the transmission mechanism with the first sprocket shaft (12), and the outer shell of which is fixed onto the bracket (1).

5. The in-situ successively fixing rolling type holding device for use in a low-temperature environmental test chamber as claimed in claim 2, which is characterized in that the fixing device used for fixing the test article (9) is arranged on the part of the bracket (1) at the test position in the low-temperature environmental test chamber. The fixing device includes:
a lower fixing device (8), which is fixed on the bracket (1) for supporting the test article (9); and
an upper fixing device (7), which is fixed on the bracket (1) for pressing down the test article (9).

6. The in-situ successively fixing rolling type holding device for use in a low-temperature environmental test chamber as claimed in claim 5, which is characterized in that the lower fixing device includes:
a support rod (14), the lower end of which is fixedly connected with the bracket (1); and
the first disc (15), the lower surface of which is fixedly connected with the upper end of the support rod (14) and the upper end of which is in contact with the lower surface of the test article (9).

7. The in-situ successively fixing rolling type holding device for use in a low-temperature environmental test chamber as claimed in claim 6, which is characterized in that the upper fixing device includes:
a support frame (16), which is fixed onto the bracket (1);
an electric push rod (17), the outer shell of which is fixed onto the support frame (16) and the telescopic end of which is vertically downward; and
the second disc (18), the upper surface of which is fixedly connected with the telescopic end of the electric push rod (17) and the lower surface of which is in contact with the upper surface of the test article (9);
The electric push rod (17) moves downwards to drive the second disc (18) to move downwards and cooperate with the first disc (15) to clamp the test article (9).
